(19) United States
(12) Patent Application Publication
(10) Pub. No.: US 2025/0079954 A1
(43) Pub. Date: Mar. 6, 2025

(54) METHOD AND DEVICE FOR PRESSING A REINFORCING SLEEVE ONTO A ROTOR OF AN ELECTRIC MOTOR

(71) Applicant: SCHUNK KOHLENSTOFFTECHNIK GMBH, Heuchelheim (DE)

(72) Inventors: Volker BIER, Fronhausen (DE); Marcel DRÖSSLER, Gießen (DE)

(73) Assignee: SCHUNK KOHLENSTOFFTECHNIK GMBH, Heuchelheim (DE)

(21) Appl. No.: 18/293,130

(22) PCT Filed: Jul. 30, 2021
(86) PCT No.: PCT/EP2021/071477

§ 371 Date: Jan. 29, 2024

(51) Int. Cl. H02K 15/14; H02K 15/02

(52) U.S. Cl. CPC H02K 15/14; H02K 15/02; H02K 2213/03; H02K 2215/00

(57) ABSTRACT

A method for pressing a reinforcing sleeve onto a rotor of an electric motor, including: affixing a press ring having a stop to the reinforcing sleeve so that the stop abuts an end face of the reinforcing sleeve, and at least one annular and/or ring-segment-shaped section of the press ring embraces at least one annular and/or ring-segment-shaped section of the reinforcing sleeve that terminates at the end face of the reinforcing sleeve; and pressing the reinforcing sleeve onto the rotor, the reinforcing sleeve being centered relative to the rotor so that a longitudinal axis of the reinforcing sleeve is aligned with a longitudinal axis of the rotor, and a pressing force being applied to the pressing ring affixed to the reinforcing sleeve.

### FIELD

The present invention relates to a method for pressing a reinforcing sleeve onto a rotor of an electric motor. The invention also relates to a device for carrying out such a method.

### BACKGROUND

Rotors of electric motors may be subjected to considerable centrifugal forces at high speeds. In particular, rotors that are composed of multiple components should therefore be designed so as to be very stable.

For example, a plurality of magnets may be attached to rotors of certain electric motors. The magnets may be held by an axial carrier body, for example in suitable receiving pockets of the carrier body. To prevent the magnets from detaching from the carrier body and/or being subjected to excessive stress by high centrifugal forces, or to stiffen the rotor as a whole, the rotor may be combined with a reinforcing sleeve that preloads the magnets or other components of the rotor with a compressive force that counteracts the centrifugal forces. Such a reinforcing sleeve, also known as a bandage, may be made of metal or a carbon-fiber-reinforced plastic (CFRP), for example.

The reinforcing sleeve may, for example, be pressed onto the rotor, thus creating an interference fit with the rotor. Depending on the desired preload, this may require very high axial pressing forces, so that the reinforcing sleeve may be damaged. At the same time, the highest possible preload is desirable in order to improve the speed stability of the rotor.

International patent application PCT/EP2020/080224 filed by the applicant at an earlier date describes a method and a device for joining a reinforcing sleeve to a rotor of an electric motor, according to which vacuum suckers are attached to an outer circumferential surface of the reinforcing sleeve, with the aid of which forces acting in the pressing direction are transferred to the reinforcing sleeve.

### SUMMARY

There may therefore be a need for a method of pressing a reinforcing sleeve onto a rotor of an electric motor whereby damage to the reinforcing sleeve during pressing onto the rotor may be avoided. There may also be a need for a corresponding device.

Such a need may be met by the subject-matter of the independent claims. Advantageous embodiments are presented in the dependent claims, the following description and the attached Figures.

A first aspect of the invention relates to a method for pressing a reinforcing sleeve onto a rotor of an electric motor. The method comprises at least the following steps: affixing a press ring having a stop to the reinforcing sleeve so that the stop abuts an end face of the reinforcing sleeve, and at least one annular and/or ring-segment-shaped section of the press ring embraces at least one annular and/or ring-segment-shaped section of the reinforcing sleeve that terminates at the end face of the reinforcing sleeve; and pressing the reinforcing sleeve onto the rotor, the reinforcing sleeve being centered relative to the rotor so that a longitudinal axis of the reinforcing sleeve is aligned with a longitudinal axis of the rotor, and a pressing force being applied to the press ring affixed to the reinforcing sleeve in the direction of the aligned longitudinal axes so that the pressing force is introduced into the reinforcing sleeve via the stop.

A second aspect of the invention relates to a device for pressing a reinforcing sleeve onto a rotor of an electric motor. The device comprises at least the following components: a press ring having a stop, the press ring being affixable to the reinforcing sleeve such that the stop abuts an end face of the reinforcing sleeve, and at least one annular and/or annular segment portion of the press ring embraces at least one annular and/or ring-segment-shaped section of the reinforcing sleeve that terminates at the end face of the reinforcing sleeve; and a press for applying a pressing force to the press ring affixed to the reinforcing sleeve.

It is noted that features of the method described above and below may also be understood as features of the device described above and below, and vice versa.

The reinforcing sleeve may be a tubular, annular or cylindrical body which preloads at least one section of the rotor in the pressed state around its circumference with a radially inward compressive force. The reinforcing sleeve may, for example, be made of a plastic, a fiber-plastic composite such as carbon, aramid, or fiberglass reinforced plastic, a metal, a metal alloy, or a combination of at least two of the foregoing examples. The inner diameter of the reinforcing sleeve may be smaller than the outer diameter of the rotor by a certain tolerance value, the tolerance value being chosen depending on a preload force to be achieved, with which the rotor is to be preloaded in the radial direction.

The press ring may also be a tubular, annular or cylindrical body or a ring-segment-shaped body. In the latter case, the press ring may be slotted in at least one place and its diameter may be varied by reducing the size of the respective slot, for example by means of one or more screws or other suitable clamping means. The press ring therefore has good elastic deformability in the radial direction. This also allows the press ring to be fixed, that is to say, clamped, to the reinforcing sleeve if required. In some embodiments, the press ring may also be referred to as a clamping ring. However, the press ring may also be unslotted, provided that the press ring has a certain elastic deformability in the radial direction. The radial compressive force exerted by the press ring on the reinforcing sleeve due to the dilatation of the reinforcing sleeve during press-fitting should at any rate be high enough to prevent radial expansion or buckling of the portion of the reinforcing sleeve embraced by the press ring as a result of the pressing force acting on the reinforcing sleeve. The press ring may be in one, two or more parts. For example, the press ring may comprise two or more than two annular and/or ring-segment-shaped press ring parts that are combinable with each other to form a ring or ring segment. The press ring may be made of the same or similar material or materials as the reinforcing sleeve.

For example, the press ring may be pushed onto the reinforcing sleeve with no or very little force before press-fitting, especially if the reinforcing sleeve is relatively thin-walled. Due to the dilatation of the reinforcing sleeve as a result of the press-fitting, the press ring then exerts a corresponding compressive force in the radial direction on the portion of the reinforcing sleeve embraced by it. Alternatively, the press ring may be clamped to the reinforcing sleeve before press-fitting, provided the sleeve is sufficiently stable. In this way, the reinforcing sleeve may be radially compressed, that is to say, preloaded with a radial compressive force, in the section embraced by the press ring.

The term “stop” may be understood to mean a stage as far as which the reinforcing sleeve may be maximally pushed into the press ring. The stop may be formed, for example, as an annular and/or ring-segment-shaped, stepped pressing surface, hereinafter also referred to as a stop surface, which extends in a plane oriented obliquely or perpendicularly to a longitudinal axis of the press ring. Such a stop may be provided, for example, by a corresponding recess along an end face of the press ring. The pressing surface may be annular, in particular circular. A width of the pressing surface, that is to say, a difference between an outer radius and an inner radius of the pressing surface, may approximately correspond to a wall thickness of the reinforcing sleeve to be pressed. For example, the width of the pressing surface may be 30% to 300%, preferably 70% to 130%, of the wall thickness of the reinforcing sleeve. For many applications, this means that the width of the pressing surface is between 0.1 mm and 10 mm, preferably between 0.5 mm and 3 mm. The width of the pressing surface may account for only a relatively small proportion of the wall thickness of the press ring, that is to say, the width of the pressing surface usually corresponds to less than half, preferably less than 20%, of the wall thickness of the press ring. With the remaining wall thickness, the press ring may form the annular and/or ring-segment-shaped section with which the press ring may embrace the annular and/or ring-segment-shaped section of the reinforcing sleeve and support it radially from the outside. This supporting section of the press ring may have a width similar to or greater than the width of the pressing surface of the stop, so that the supporting section of the press ring may absorb the forces exerted on it in the radial direction during press-fitting of the reinforcing sleeve without being damaged.

Centering of the reinforcing sleeve relative to the rotor may be done manually and/or mechanically, for example by means of a corresponding guide for guiding a movement of the reinforcing sleeve relative to the rotor and/or by means of a centering cone.

The term “press” may be understood to mean a device for generating and applying pressing force and for absorbing corresponding reaction forces. For example, the press may be a hydraulic press or a hand lever press.

Using the method or device described above and below, the axial force acting on the reinforcing sleeve when it is pressed onto the rotor to obtain a longitudinal press-fit may be significantly increased without any relevant damage to the reinforcing sleeve, in particular in the areas close to its edges. This allows the use of reinforcing sleeves with an even greater underdimension compared to the rotor and consequently even stronger preloading of the rotor in the radial direction. This may further improve the speed stability of the rotor. In particular, this allows efficient processing of relatively thin-walled (carbon) fiber-reinforced plastic sleeves as reinforcing sleeves. Such reinforcing sleeves may, for example, have a wall thickness of 3 mm or less, particularly 2 mm or less, and a diameter of 50 mm or less, particularly 25 mm or less.

“Press-fitting” may be understood above and below as a pressing process in which the rotor and the reinforcing sleeve are moved relative to each other in opposite axial directions by applying a pressing force to the reinforcing sleeve. This may be done by moving the reinforcing sleeve towards the fixed rotor, moving the rotor towards the fixed reinforcing sleeve, or moving the reinforcing sleeve and rotor towards each other simultaneously.

Without limiting the scope of the invention in any way, ideas and possible features relating to embodiments of the invention may be considered to be based, inter alia, on the ideas and findings described below.

According to one embodiment, a fiber-reinforced plastic sleeve may be used as the reinforcing sleeve. The plastic sleeve may be reinforced with carbon fibers, aramid fibers and/or glass fibers, for example. The plastic sleeve may be formed from a plurality of layers of such fibers held together by a suitable plastic matrix. The plastic matrix may comprise, for example, a thermoplastic or thermoset, in particular epoxy resin. Such a reinforcing sleeve has very high rigidity and load-bearing capacity in the radial direction and very high strength for relatively low weight. If such a reinforcing sleeve is pressed onto the rotor, the rotor may be preloaded particularly strongly in the radial direction, which has a positive effect on its speed stability. Due to the relatively low coefficient of expansion of the fiber-reinforced plastic, this may also minimize temperature-related fluctuations in the radial preload force with which the rotor is preloaded by means of the reinforcing sleeve. In other words, reinforcing sleeves made of carbon fiber-reinforced plastic, for example, undergo only very slight dimensional changes at fluctuating temperatures, so that they may provide very good stabilization of the rotor even at temporarily elevated operating temperatures.

However, it has been observed that thin-walled fiber-reinforced plastic sleeves in particular may not always easily withstand the axial forces occurring during press-fitting, so that up to now there has been a risk of the plastic sleeves being damaged during press-fitting.

By means of the press ring described above and below, it is now possible to prevent in particular outer fiber layers of the reinforcing sleeve from being damaged or deformed when pressed onto the rotor.

According to one embodiment, an outer diameter of the reinforcing sleeve may be smaller than 50 mm, in particular smaller than 25 mm. Additionally or alternatively, an inner diameter of the reinforcing sleeve may be smaller than an outer diameter of the rotor by at least 0.1 mm, in particular by at least 0.2 mm. The reinforcing sleeve may for example have a wall thickness of less than 2 mm, preferably less than 1 mm or even less than 0.5 mm. In certain applications, even reinforcing sleeves with a wall thickness of only 0.3 mm may serve as bandages for rotors. Reinforcing sleeves with such dimensions may be particularly sensitive to increased pressing forces. Furthermore, due to the correspondingly reduced circumferential surface of the reinforcing sleeve, it is difficult to attach additional holders to the outside of the reinforcing sleeve as described, for example, in the aforementioned PCT/EP2020/080224, thus possibly reducing part of the pressing force acting on the end face of the reinforcing sleeve. Such measures are unnecessary thanks to the process described above and below, as it has been observed that adverse effects of very high pressing forces on such reinforcing sleeves may be altogether avoided in this way. In certain situations, however, it may make sense to combine the method with such measures.

According to one embodiment, the pressing force may be at least 20 kN, in particular at least 30 kN. It has been observed that, with pressing forces of this magnitude, the reinforcing sleeve is damaged more often when the reinforcing sleeve is pressed in the conventional way. On the other hand, such high pressing forces are desirable in order to achieve a correspondingly strong radial preload of the rotor. However, tests have shown that the reinforcing sleeve is not damaged under such pressing forces when the reinforcing sleeve is press-fitted using the method described above and below.

According to one embodiment, the reinforcing sleeve may be centered relative to the rotor and/or pressed onto the rotor via a centering cone disposed between the reinforcing sleeve and the rotor and widening towards the rotor. The centering cone may, for example, be conical or frustoconical at least in sections. The width of the centering cone may increase steadily towards the rotor. The width may increase linearly and/or non-linearly. In this way, the reinforcing sleeve may be positioned very precisely relative to the rotor without additional measures, so that, for example, tilting of the reinforcing sleeve may be avoided. In addition, such a centering cone may be used to gradually widen the reinforcing sleeve to an outer diameter of the rotor, making it possible to reduce the pressing force required for press-fitting of the reinforcing sleeve while maintaining the radial preload of the rotor.

According to one embodiment, a largest outer diameter of the centering cone may be larger than an inner diameter of the reinforcing sleeve. Additionally or alternatively, the largest outer diameter of the centering cone may be at least as large as an outer diameter of the rotor. In other words, at its widest point the centering cone may be at least as wide as the rotor. The rotor may be cylindrical with a constant outer diameter. This may further simplify the press-fitting of the reinforcing sleeve onto the rotor.

According to one embodiment, the press ring may have at least one slot connecting a first end face of the press ring to a second end face of the press ring opposite the first end face, and an adjustment device for adjusting a width of the slot. The slot may be, for example, an axial slot or a slot running diagonally on a slant between the first and second end faces. In the simplest case, the adjustment device may be realized by a screw connection. However, it is also possible, for example, to have a quick-clamping device operable by means of a lever or a spring clamping device for radial preloading of the press ring by spring force. In this way, the diameter of the press ring may be precisely adapted to reinforcing sleeves of different sizes.

According to one embodiment, the press ring may have two ribs on its outer surface, each rib extending along a longitudinal edge of the slot. In this case the adjustment device may be configured to press the two ribs together so that the width of the slot is reduced. “Rib” may be understood to mean an elongated projection on an outer circumferential surface of the press ring. The two ribs may run substantially parallel to each other. The inner diameter of the press ring may be very simply and effectively reduced with the aid of such a clamping flange.

According to one embodiment, the stop may comprise an annular and/or ring-segment-shaped stop surface extending at least partially along an inner circumference of the press ring. The stop surface may be axially offset with respect to an end face of the press ring, with a portion of an inner circumferential surface of the press ring, which connects the end face to the stop surface, acting as a clamping surface for embracing at least a portion of the outer circumferential surface of the reinforcing sleeve. Such a stop may be provided very easily, for example by creating a corresponding stepped recess on one of the end faces of the press ring.

It is noted that possible features and advantages of embodiments of the invention are described above and below partly with reference to a method of pressing a reinforcing sleeve onto a rotor of an electric motor, and partly with reference to a device particularly designed to carry out this method. A person skilled in the art will recognize that the features described for individual embodiments may be transferred, adapted and/or interchanged in an analogous and suitable manner to other embodiments to arrive at further embodiments of the invention and possibly synergistic effects.

### BRIEF DESCRIPTION OF DRAWINGS

Advantageous embodiments of the invention are further explained below with reference to the accompanying drawings, in which neither the drawings nor the explanations are to be construed as limiting the invention in any way.

FIG. 1 shows a device for pressing a reinforcing sleeve onto of a rotor of an electric motor according to an embodiment of the present invention.

FIG. 2 shows a rear view of a press ring from FIG. 1.

FIG. 3 shows a sectional view through the press ring of FIG. 1 along a line of intersection III-III.

The figures are merely schematic and not to scale. Identical reference signs in the different drawings denote identical or identically acting features.

### DETAILED DESCRIPTION

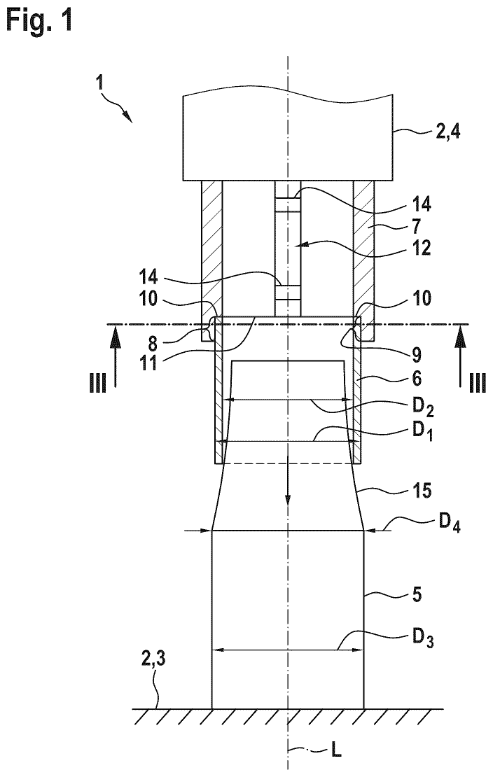

FIG. 1 shows a device 1 with a press 2, which in this example comprises a horizontal supporting surface 3 and a pressing piece 4 which may be moved in the vertical direction. A rotor 5 of an electric motor (not shown) is positioned on the supporting surface 3. A reinforcing sleeve 6 is disposed between the rotor 5 and the pressing piece 4, in this case a carbon-fiber-reinforced plastic sleeve, with which the rotor 5 is to be bandaged by pressing the reinforcing sleeve 6 axially, in this case in the vertical direction, onto the rotor 5.

In order to preload the rotor 5 by means of the press-fitted reinforcing sleeve 6 in the radial direction with a sufficiently high preload force, the reinforcing sleeve 6 is significantly underdimensioned compared to the rotor 5, so that a correspondingly high pressing force is required to press-fit the reinforcing sleeve 6, for example a pressing force of at least 20 kN, in particular at least 30 kN. The reinforcing sleeve 6 may have an outer diameter D₁ of less than 50 mm, in particular of 25 mm or less, and an inner diameter D₂ that is smaller than an outer diameter D₃ of the rotor 5 by at least 0.1 mm, for example by at least 0.2 mm.

To prevent damage to the reinforcing sleeve 6, the pressing force is not transferred directly from the pressing piece 4 to the reinforcing sleeve 6, but via a press ring 7 which is affixed to an annular outer section 8 of the reinforcing sleeve 6 facing towards the pressing piece 4. The outer section 8 is embraced by a ring-segment-shaped inner section 9 of the press ring 7.

The size ratios shown in FIG. 1 between the outer section 8 and the rest of the reinforcing sleeve 6, and between the inner section 9 and the rest of the press ring 7, respectively, are to be understood merely as examples and may differ significantly from FIG. 1 depending on the application.

Furthermore, the press ring 7 has a stop 10, the reinforcing sleeve 6 being inserted into the press ring 7 to an extent such that its end face 11 abuts the stop 10.

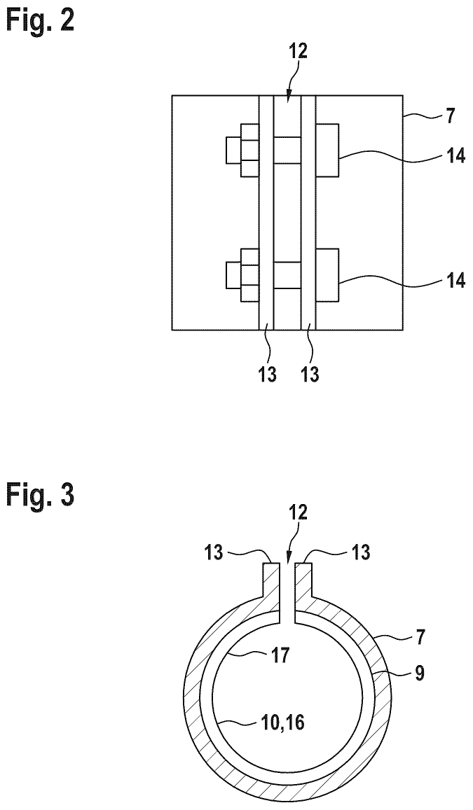

In this example, the press ring 7 has an axial slot 12 extending continuously between the two end faces of the press ring 7. A rib 13 (see FIG. 2 and FIG. 3) projecting radially outwards from the press ring 7 extends along each of the longitudinal edges of the slot 12. To reduce the width of the slot 12, the two ribs 13 may be braced together by means of two screw connections 14.

By bracing the ribs 13, it is also possible, for example, to clamp the press ring 7 to the reinforcing sleeve 6, for example in such a way that the outer section 8 is preloaded with a radial clamping force via the inner section 9.

During the actual pressing process, the reinforcing sleeve 6 is centered relative to the rotor 5 so that their respective longitudinal axes L are aligned with each other. In this example, centering is carried out with the aid of a centering cone 15 which is placed between the rotor 5 and the reinforcing sleeve 6 and which becomes increasingly wide towards the rotor 5. To prevent the reinforcing sleeve 6 from tilting and to suitably widen the reinforcing sleeve 6, the centering cone 15 has its largest outer diameter D₄ at its end facing towards the rotor 5, the largest outer diameter D₄ expediently being at least as large as the outer diameter D₃ of the rotor 5.

By reducing a vertical distance between the pressing piece 4 and the supporting surface 3, for example hydraulically or mechanically, the press ring 7 is subjected to the required pressing force, the pressing force being introduced into the reinforcing sleeve 6 exclusively, or at least for the most part, via the stop 10, so that the reinforcing sleeve 6 is pressed onto the rotor 5. The fact that the outer section 8 is compressed by the press ring 7 during the pressing process effectively prevents radial expansion of the outer section 8, for example by buckling or bulging, even under very high axial loads.

Due to the elastic screw connections 14, the press ring 7 may follow the increasing expansion of the reinforcing sleeve 6 by means of the centering cone 15 without breaking or otherwise damaging the press ring 7.

The sectional view of the press ring 7 in FIG. 3 shows that the stop 10 may comprise a ring-segment-shaped stop surface 16 which, in this example, extends continuously along an inner circumference 17 of the press ring 7, with the exception of the slot 12. (For the sake of clarity, the screw connections 14 have been omitted from FIG. 3).

Finally, it is pointed out that terms such as “having”, “comprising” etc. do not exclude other elements or steps, and terms such as “one” or “a” do not exclude a plurality. It should further be noted that features or steps that have been described with reference to one of the above embodiments may also be used in combination with other features or steps of the above embodiments described above. Reference signs in the claims are not to be considered as limitations.

### LIST OF REFERENCES

1 Device
2 Press
3 Support
4 Pressing piece
5 Rotor
6 Reinforcing sleeve
7 Press ring
8 Outer section
9 Inner section
10 Stop
11 End face
12 Slot
13 Rib
14 Screw connection
15 Centering cone
16 Stop surface
17 Inner circumference
D₁ Outer diameter of the reinforcing sleeve
D₂ Inner diameter of the reinforcing sleeve
D₃ Outer diameter of the rotor
D₄ Largest outer diameter of the centering cone
L Longitudinal axis

1-10. (canceled)

11. A method for pressing a reinforcing sleeve onto a rotor of an electric motor, the method comprising:
affixing a press ring having a stop to the reinforcing sleeve, so that the stop abuts an end face of the reinforcing sleeve, and at least one annular and/or ring-segment-shaped section of the press ring embraces at least one annular and/or ring-segment-shaped section of the reinforcing sleeve that terminates at the end face of the reinforcing sleeve; and pressing the reinforcing sleeve onto the rotor, the reinforcing sleeve being centered relative to the rotor so that a longitudinal axis of the reinforcing sleeve is aligned with a longitudinal axis of the rotor, and a pressing force being applied to the press ring affixed to the reinforcing sleeve in the direction of the aligned longitudinal axes so that the pressing force is introduced into the reinforcing sleeve via the stop.

12. The method according to claim 11,
wherein a fiber-reinforced plastic sleeve is used as the reinforcing sleeve.

13. The method according to claim 11,
wherein an outer diameter of the reinforcing sleeve is smaller than 50 mm, in particular smaller than 25 mm; and/or
wherein an inner diameter of the reinforcing sleeve is smaller than an outer diameter of the rotor by at least 0.1 mm, in particular by at least 0.2 mm.

14. The method according to claim 11,
wherein the pressing force is at least 20 kN, in particular at least 30 kN.

15. The method according to claim 11,
wherein the reinforcing sleeve is centered relative to the rotor and/or pressed onto the rotor via a centering cone disposed between the reinforcing sleeve and the rotor and widening towards the rotor.

16. The method according to claim 15,
wherein a largest outer diameter of the centering cone is larger than an inner diameter of the reinforcing sleeve and/or is at least as large as an outer diameter of the rotor.

17. A device for pressing a reinforcing sleeve onto a rotor of an electric motor, the device comprising:
a press ring having a stop, the press ring being affixable to the reinforcing sleeve such that the stop abuts an end face of the reinforcing sleeve and at least one annular and/or ring-segment-shaped section of the press ring embraces at least one annular and/or ring-segment-shaped section of the reinforcing sleeve that terminates at the end face of the reinforcing sleeve; and
a press for applying a pressing force to the press ring affixed to the reinforcing sleeve.

18. The device according to claim 17,
wherein the press ring has at least one slot connecting a first end face of the press ring to a second end face of the press ring opposite the first end face, and an adjustment device for adjusting a width of the slot.

19. The device according to claim 18,
wherein the press ring has two ribs on its outer surface, each rib extending along a longitudinal edge of the slot;
wherein the adjustment device is configured to compress the two ribs together so that the width of the slot is reduced.

20. The device according to claim 17,
wherein the stop comprises an annular and/or ring segment-shaped stop surface extending at least partially along an inner circumference of the press ring.
